(19) United States
(12) Patent Application Publication
(10) Pub. No.: US 2012/0102080 A1
(43) Pub. Date: Apr. 26, 2012

(54) COMPUTER SYSTEM AND STORAGE CAPACITY EXTENSION METHOD

(75) Inventors: Yasuhiro Kirihata, Tokyo (JP); Michael Hay, Yokohama (JP); Kota Yamaguchi, Tokyo (JP)

(73) Assignees: HITACHI SOFTWARE ENGINEERING CO., LTD., Tsurumi-ku, Yokohama (JP); HITACHI, LTD., Tokyo (JP)

(21) Appl. No.: 12/746,216

(22) PCT Filed: May 20, 2010
(86) PCT No.: PCT/JP10/03403

§ 371 Date: Jun. 4, 2010

(51) Int. Cl. G06F 17/30

(52) U.S. Cl. 707/831; 707/E17.01

(57) ABSTRACT

Provided is a computer system configured so that security compliance problems can be avoided and an access control model which can be uniquely customized can be implemented by extending the storage capacity to an external storage service by means of integrated management of an existing NAS(s) and the external storage service, and controlling the optimum data placement according to the confidentiality and importance level of data.

In a computer system according to this invention, a local storage system includes an extended server for integrating a NAS(s) existing in the local storage system with an external storage service and thereby providing a client with a storage area as a single virtual NAS.

### TECHNICAL FIELD

The present invention relates to a computer system configured to extend the capacity of an existing NAS (Network Attached Storage) to an external storage service, and also relates to a method for extending such capacity.

### BACKGROUND ART

Recently, new methods for providing IT service modules, such as SaaS or cloud computing, have been gaining attention and it is believed that the use of such service modules by companies will be extended significantly in the future.

The major reason for the above belief is reduction in retention and operation cost by means of switching from Ownership of an IT system to Use thereof. In a case where a company owns an IT system, it has the advantage that the company can construct its own unique system fully customized for the company. However, on the other hand, it has the disadvantage of a great amount of cost such as cost for introduction and construction of the IT system, cost for daily operation such as backups and dealing with failures, and cost for disaster countermeasures by installation of a standby system at a remote data center.

If part of the owned IT system is substituted with a service module provided by an outside SaaS/cloud service module companies and the use of the IT system is thereby incorporated, the resultant system may not be optimized for the in-house use as much as the unique system for the company, but it has the effect of greatly reducing the introduction and operation cost.

However, a significant problem in using the outside IT service modules is security and compliance issues. Since it is basically difficult to control the outside IT system, if IT resources and confidential information such as customer information and personnel information belonging to the company are stored in the outside IT system, the problem is how to ensure the security.

Also, if data is located outside the company, the data cannot be managed fully and data cannot be stored sufficiently according to audits and agreements with customers. Therefore, there may be a case where the compliance cannot be achieved. When constructing a system in which an outside IT service module is mixed in an internal storage system as described above, it is necessary to locate data according to the confidentiality and importance level of the data in the system.

On the other hand, many companies introduce NASes as file storage devices to achieve efficiency in retention and management of files. A system/method capable of making good use of existing IT resources and cooperating with an external service module is required in order to enhance a system at a local site. The main purpose of having the external service module cooperate with the storage system using NASes is to extend the storage capacity and operate the storage system.

As the related conventional technique, Japanese Patent Laid-Open (Kokai) Application Publication No. 2004-46661 discloses a system for integrated management of existing NASes and extension of the storage capacity. This suggests integrated management of all the NASes including existing NASes by inheriting a directory tree configuration of the existing NASes and including a new NAS to construct a virtual directory tree. As a result, if an administrator wants to extend the capacity of the existing NASes, the capacity of NASes can be easily extended simply by adding a new NAS having the above-described function.

Incidentally, examples of related conventional techniques relating to shared management of files in distributed storage systems are Japanese Patent Laid-Open (Kokai) Application Publication No. 2005-276094 and Japanese Patent Laid-Open (Kokai) Application Publication No. 2008-33519.

### CITATION LIST

### Patent Literature

PTL 1: Japanese Patent Laid-Open (Kokai) Application Publication No. 2004-46661
PTL 2: Japanese Patent Laid-Open (Kokai) Application Publication No. 2005-276094
PTL 3: Japanese Patent Laid-Open (Kokai) Application Publication No. 2008-33519

### SUMMARY OF INVENTION

### Technical Problem

An external online storage service normally publicizes an interface such as Web API based on REST/SOAP or iSCSI and does not necessarily takes the form of retaining a directory tree like a NAS. Also, since a NAS server accesses data in an external online storage service via a WAN, its I/O performance relative to files in the external online storage service is limited.

The system disclosed in Japanese Patent Laid-Open (Kokai) Application Publication No. 2004-46661 only provides the existing NASes constructed in a LAN with a mechanism for integrated management and capacity extension of the NASes and no consideration is given to the capacity extension to an online storage service existing over the WAN. Also, the system disclosed in Japanese Patent Laid-Open (Kokai) Application Publication No. 2004-46661 does not provide a mechanism for enhancing the performance of the NASes when configuring the environment where the external storage service is fused with the NASes in a local area over the WAN.

Furthermore, regarding the security compliance, no mechanism for realizing the optimum data placement according to the confidentiality and importance level of information is disclosed. The need for sharing of an integrated system by a plurality of organizations or departments is high in the environment where the NASes in the local area are integrated with the external storage service.

However, standard access control for a CIFS/NFS provided by the existing NASes may be sometimes insufficient in terms of security operation. For example, access control for the CIFS/NFS is classified as DAC (Discretionary Access Control), so that files retained by a user can be publicized to an arbitrary party as the user who is a file holder wishes.

If the administrator wishes to prevent illegal copying of files and operate a NAS shared by a plurality of departments, MCS (Multi Category Security) provides higher security and is more suited for actual operation. Japanese Patent Laid-Open (Kokai) Application Publication No. 2004-46661 does not support switching of a security module like switching of access control from the DAC to the MCS for the integrated operation of the NASes at the local site and the online storage service.

In order to solve the above-described problems, it is an object of the present invention to provide a computer system configured so that the security compliance problems can be avoided and an access control model which can be uniquely customized can be implemented by extending the storage capacity to an external storage system by means of integrated management of existing NASes and an external storage service and controlling the optimum data placement according to the confidentiality and importance level of data.

Another object of the invention is to realize a computer system that manages, by means of a database, the addresses of files, logical file paths, and their related metadata existing in existing NASes and an online storage service and has an integrated file management function including the NASes and the online storage service in order to realize the integrated management of the existing NASes and the online storage service.

Moreover, another object of the invention is to provide a computer system, with regard to data placement, that prohibits storage of highly confidential data in the online storage service and enables encrypted storage of other data to be stored in the online storage service.

Furthermore, another object of the invention is to provide a computer system that analyzes sessions with a CIFS/NFS, installs a proxy function performing access control by referring to a security attribute assigned to each user and each file, and can add a unique access control model in order to realize an access control model which can be customized.

### Solution to Problem

In order to achieve the above-described objects, the computer system according to this invention is characterized in that an extended server for integrating NASes existing in a local storage system with an external storage service and providing a storage area as a single virtual NAS to clients is provided in the local storage system.

### Advantageous Effects of Invention

According to this invention, it is possible to provide a computer system configured so that security compliance problems can be avoided and an access control model which can be uniquely customized can be implemented by extending the storage capacity to an external storage service by means of integrated management of existing NASes and the external storage service, and controlling the optimum data placement according to the confidentiality and importance level of data.

### BRIEF DESCRIPTION OF DRAWINGS

FIG. 1 is a block configuration diagram of a computer system according to this invention.

FIG. 2 is a block diagram showing the file allocation in a file server for the computer system.

FIG. 3 shows the table configuration of data retained by a file attribute DB.

FIG. 4 is a file property screen displayed on a user terminal by an extended attribute setting module.

FIG. 5 is a file edit screen by the extended attribute setting module.

FIG. 6 is a flowchart illustrating processing for opening a file.

FIG. 7 is a flowchart illustrating file read processing.

FIG. 8 is a flowchart illustrating file write processing.

FIG. 9 is a flowchart illustrating access control processing by a custom access control plug-in module.

FIG. 10 is a flowchart illustrating data placement processing according to a policy.

FIG. 11 is a block diagram showing the details of a unique access control mechanism that can be customized by the user by means of the extended attribute setting module.

FIG. 12 is a block diagram of a computer system according to a second embodiment.

FIG. 13 is a block diagram explaining the operation of the computer system shown in FIG. 12.

FIG. 14A is a flowchart illustrating the operation of the computer system shown in FIG. 12.

FIG. 14B is a flowchart illustrating processing executed following the processing shown in FIG. 14A.

FIG. 15 is a block diagram showing a computer system according to a third embodiment of this invention.

FIG. 16A is a first block diagram explaining processing for updating an original data file.

FIG. 16B is a second block diagram explaining the processing for updating the original data file.

FIG. 17 is a flowchart illustrating the processing for updating the original data file.

FIG. 18 is a block diagram showing a file set of the original data file and derived data files.

FIG. 19 is a table showing the data configuration of nodes constituting a file set.

FIG. 20 is a block diagram explaining the operation to set the tree configuration to the nodes.

FIG. 21 is a policy table specifying commit policies.

FIG. 22 is a flowchart illustrating commit processing.

FIG. 23 is a block diagram of a file set, showing how to reproduce a commit file.

### DESCRIPTION OF EMBODIMENTS

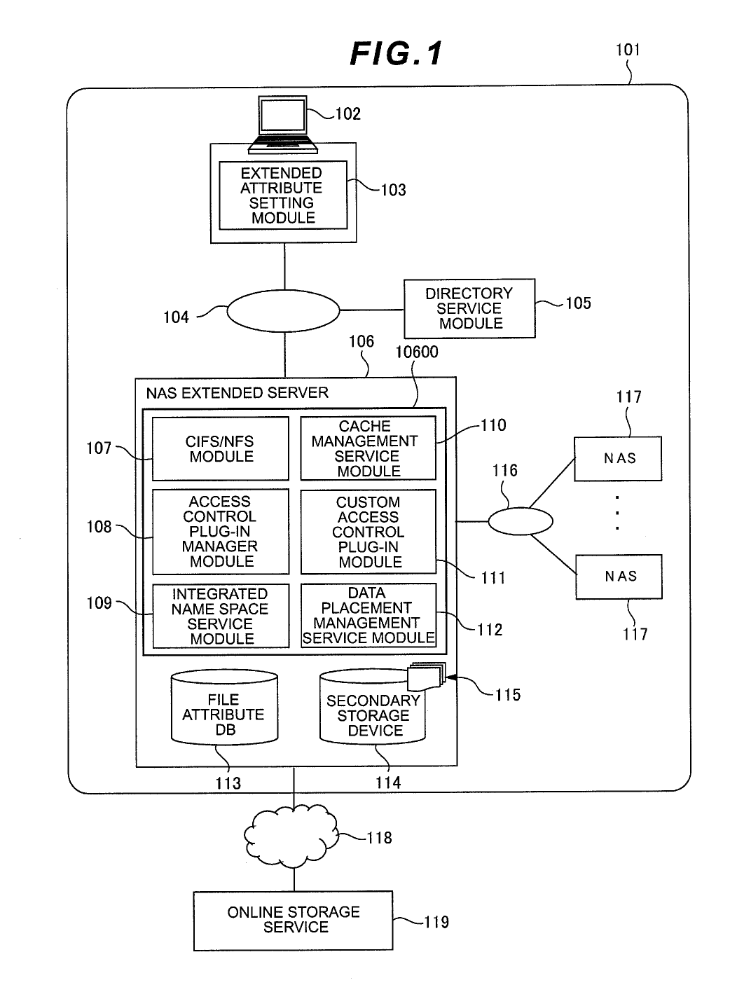

The present invention will be explained in detail with reference to the attached drawings. It should be noted that this invention will not be limited by the following explanation FIG. 1 is a block configuration diagram of a computer system according to this invention. This computer system includes a NAS extended server 106 for integrating a plurality of NASes existing in a local area 101 such as a company/organization and extending this integration to an external online storage service.

A plurality of existing NASes 117 connected via a NAS connection LAN 116 to the NAS extended server 106 exist in the local storage system 101. Furthermore, a user terminal 102 and a directory service module 105 are connected via a LAN 104 to the NAS extended server 106.

The existing NASes 117 are connected to the NAS extended server 106 via the NAS connection LAN 116 in order to prevent direct access from the user terminal 102 to the NASes 117 and also prevent consumption of the LAN 104 band by data transfer between the NAS extended server 106 and the NASes 117. There is an online storage service 119 outside the local storage system and the online storage service 119 is connected via a WAN 118 to the NAS extended server 106.

The online storage service 119 is a service module for lending storage areas as provided by, for example, a service module provider on the Internet; and a representative service module is Amazon S3 (trademark).

In a case of Amazon S3, a means of access to an online storage service is a method of using a Web API publicized by Amazon. The use of the Web API enables a user to have the NAS extended server 106 access files on the online storage service to perform operations such as file creation, update, or deletion.

The directory service module 105 is a service module for managing information resources such as user account information and a security attribute(s), and a representative example of the directory service module 105 is Active Directory. The security attribute(s) for each user, which is used for unique access control, is managed by this directory service module 105.

An extended attribute setting module 103 is installed in the user terminal 102. This is a client application necessary to access files in the NAS extended server 106 in which a unique access control function is implemented. Even if the user terminal 102 in which this module is not installed accesses the NAS extended server, it cannot access a file or directory to which the security attribute based on a unique access control model is assigned.

The user terminal 102 in which this module is installed can set access control based on the unique access control to a user. This access control method will be explained later. The user terminal 102 provides the user with a function that sets the security attribute defined by the unique access control model to the file access, using the application.

The NAS extended server 106 includes a NAS extension program 10600; and the NAS extension program 10600 implements a CIFS/NFS module 107, an access control plug-in manager 108, an integrated name space service module 109, a cache management service module 110, a custom access control plug-in module 111, and a data placement management service module 112. Also, the NAS extended server includes a file attribute DB 113, a secondary storage device 114, and policy data 115. Incidentally, each module may be implemented by dedicated hardware.

The CIFS/NFS module 107 has a proxy function that receives and analyzes a file access request according to CIFS/NFS protocol from the user terminal 102, and transfers access to a target NAS 117 or applies the file operation using the Web API to a target file in the online storage service 119.

the access control plug-in manager module 108 is an application for managing the custom access control plug-in module 111. The custom access control plug-in module 111 is a module for realizing the unique access control that is set, defined, or requested by the user terminal 102; and implements a function applying the unique access control to the file access based on the request analyzed by the CIFS/NFS module 107.

A possible example of the unique access control for the NAS extended server is a method like Multi Category Security of setting category attributes to users, and files or directories and determining accessibility depending on their inclusion relation.

As an example of the above-described access control, assuming that there are users A, B and files X, Y and category attributes C1, C2, C3 are defined, {C1}, {C1,C2} are assigned to the users A, B respectively, and {C1,C2}, {C1,C3 } are assigned to the files X, Y respectively.

In this case, the category attribute set for the file X is not included in the category attribute set for the user A, but included in the category attribute set for the user B. Accordingly, the file X cannot be accessed by the user A, but can be accessed by the user B. Furthermore, since the category attribute set for the file Y is not included in either of the category attribute sets for the users A, B, the file Y cannot be accessed by either the user A or the user B.

If the user can access a file, the custom access control plug-in module 111 can further apply the security attribute such as READ, WRITE, ADD, or EXECUTE as additional access control characteristics to the file operation or partially merge an access control attribute of the existing CIFS/NFS.

Furthermore, the extended attribute setting module 103 can also incorporate an RBAC (Role Based Access Control) mechanism and set an access control model necessary to achieve efficiency in the security operation to the computer system, so that only a user who is assigned the role as a security administrator can change the above-mentioned category attributes and access characteristics.

A mechanism based on application of the MCS, RBAC access control mechanisms described in the aforementioned example to access to the existing NASes 117 or the online storage service 119 will be explained below, but the following explanation is not intended to preclude other access control models.

The integrated name space service module 109 manages association of logical file paths for files in all the NASes 117 and the online storage service 119 under the control of the NAS extended server 106 with real file addresses, which are actual file locations, and provides a virtually integrated directory configuration to the user terminal 102. The file attribute DB 113 is a database that stores attribute information about each file and also stores information about the logical file paths and real file addresses (which may be called the real file paths) used by the integrated name space service module 109.

The cache management service module 110 has the NAS extended server 106 implement a local cache function that realizes high-speed access processing when a file stored in the online storage service 119 is accessed. The NAS extended server 106 has a cache area for caching files stored in the online storage service 119.

Specifically speaking, when a cache read/write request is issued from the user terminal 102, the NAS extended server 106 implements a function that reads or writes a corresponding cache file stored in the secondary storage device 114 in response to the request, returns the result to the user terminal 102, deletes the cache file which has not been accessed for a certain period of time, and migrates it to the online storage service.

The policy data 115 are data in which policies for placement management of files in all the NASes 117 and the online storage service 119 under the control of the NAS extended server 106 are described. Rules for file migration based on the file attributes, for example, rules specifying that a file which has not been accessed more than one month should be migrated from the NAS 117 to the online storage service 119 or a highly confidential file should be migrated only to a designated NAS 117, are described as policy data in policy files.

The data placement management service module 112 implements a function that actually migrates or deletes a cache file in the secondary storage device 114 or a file in the NAS 117 or the online storage service 119 according to the rules regarding the data placement as described in the policy data. This service module periodically checks the attributes of files and executes asynchronous file data migration on a target file which is not opened.

Incidentally, the directory service module 105, the CIFS/NFS module 107, the access control plug-in manager 108, the integrated name space service module 109, the cache management service module 110, the custom access control plug-in module 111, the data placement management service module 112, and the online storage service 119 are implemented by appropriate hardware resources and software resources.

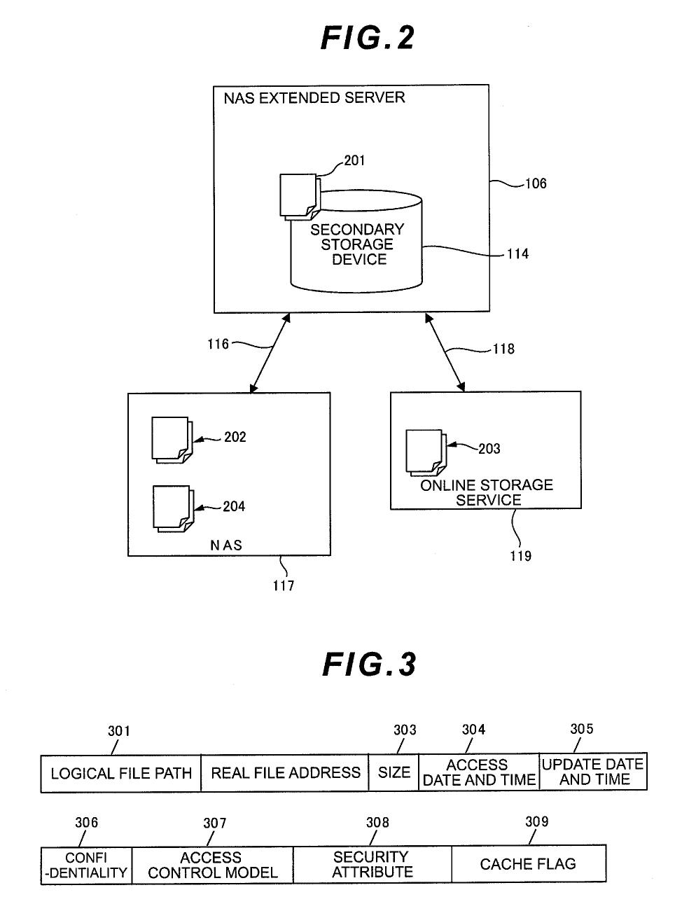

FIG. 2 is a block diagram showing the file allocation in the file server for the computer system. Cache files 201 exist in the secondary storage device 114 for the NAS extended server 106.

This is to execute processing for executing processing for accessing the online storage service 119 at a high speed. The data placement management service module 112 serves to store a high-frequency access file group 202 and a confidential file group 204 in the NAS 117 and store a low-frequency access file group 203 in the online storage service 119.

As files whose access frequency is high are stored in the NASes 117 in the company/organization, access performance from the client to the files is enhanced. Also, confidential files such as customer information and personnel information are stored in the NASes 117, but not in the online storage service 119, thereby avoiding security compliance problems. Files whose access frequency is low are stored in the online storage service 119, thereby reducing the entire storage cost. The low-frequency access file group 203 is encrypted and then stored in the online storage service 119, thereby further strengthening security.

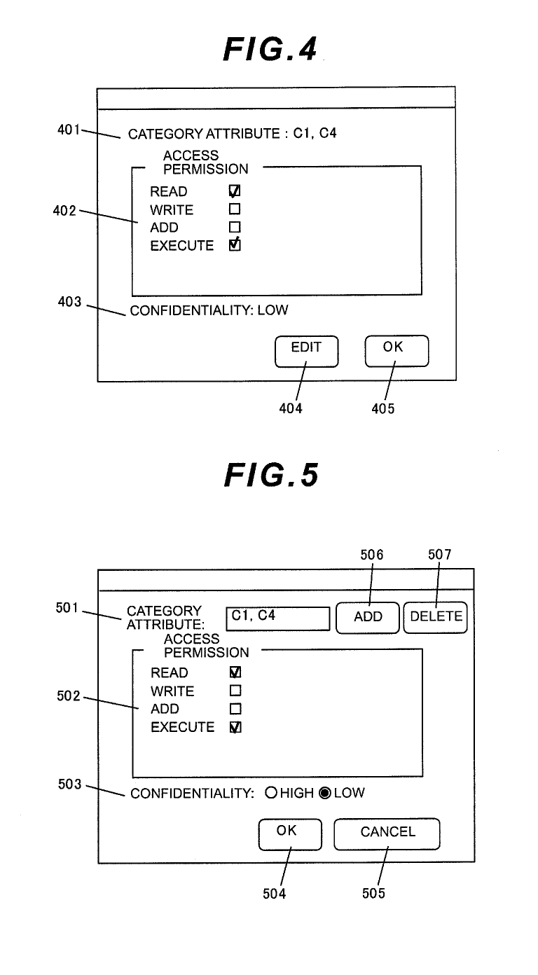

FIG. 3 shows the table configuration of data retained by the file attribute DB 113.

Attribute values defined in the table are a logical file path 301, real file address 302, size 303, access date and time 304, update date and time 305, confidentiality 306, access control model 307, security attribute 308, and cache flag 309.

The logical file path 301 is a file path as seen from the user terminal 102. The NAS extended server 106 integrates the NASes 117 with the online storage service 119 and shows them as a single virtual NAS to the user terminal 102. The logical file path corresponds to a file path based on a virtually integrated directory.

The real file address 302 is file allocation information for specifying the location where the relevant file is actually stored. The NAS extended server 106 uses this information to access, and applies processing such as read or write processing on, a target file in a target NAS 117 or a target file in the online storage service 119.

The size 303 indicates the size of the relevant file. The access date and time 304 is the latest access date and time information and the update date and time 305 is update date and time information. The confidentiality 306 is a value defining the confidentiality of the target file and can be set by the user to each file via a GUI screen on the extended attribute setting module 103. Whether the relevant file can be stored in the online storage service 119 or not is judged based on this confidentiality value.

The access control model 307 is an attribute value indicating under which access control model the security for the target file and/or directory is set. Depending on this value, the data format for the security attribute 308 will change and processing executed by the custom access control plug-in module 111 for actually interpreting the security attribute will change.

The security attribute 308 is a security attribute value assigned to the target file or directory according to the access control model. Examples of the security attribute 308 include categories assigned to the file or directory and attributes relating to access characteristics such as READ or WRITE.

The cache flag 309 is a flag relating to a file stored in the online storage service 119 and indicates whether the file is cached in the secondary storage device in the NAS extended server or not.

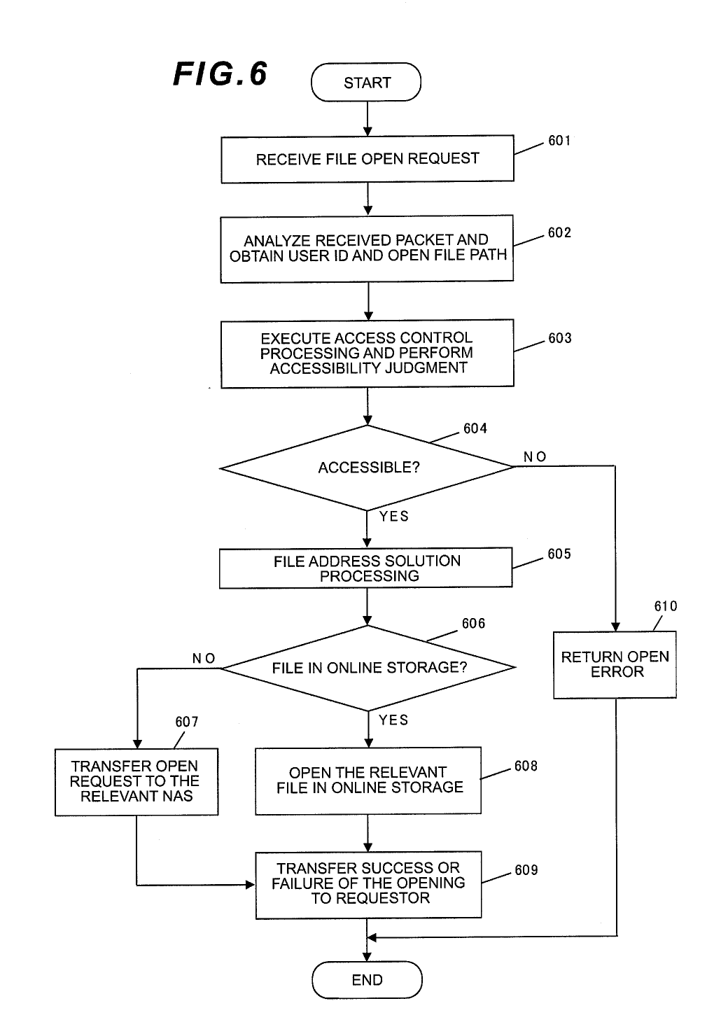

FIG. 4 is a file property screen displayed by the extended attribute setting module 103 on the user terminal 102. A category attribute 401 displayed on the screen indicates category attributes currently assigned to the relevant file. A pane 402 for access permission indicates whether four types of access, READ, WRITE, ADD, and EXECUTE, are possible or not.

In the setting example shown in this drawing, access relating to READ and EXECUTE is permitted. Confidentiality 403 indicates the confidentiality of the target file and FIG. 4 shows that the confidentiality is set to LOW.

An edit button 404 is button to invoke a property edit screen to edit the file attributes on the setting screen.

If RBAC is adopted as an edit function, for example, a user who is assigned the role as a security administrator can change the setting. As shown in FIG. 4, a strong security function that could not be realized by DAC mounted on a conventional NAS can be realized by the mechanism that allows only a user, who is not the owner of the relevant file, but is duly authorized, to change the security attribute or the confidentiality setting.

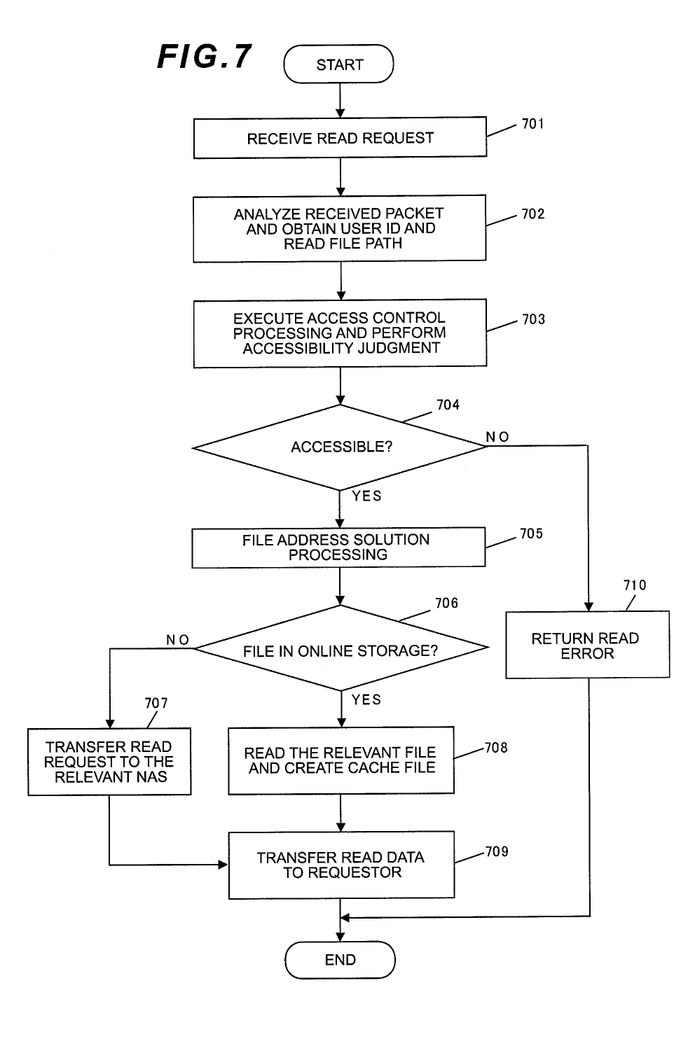

FIG. 5 shows the property edit screen by the extended attribute setting module 103. The category attribute(s) can be added or deleted by the administrator pressing an add button 506 or a delete button 507. An access permission pane 502 is designed so that a check box for each access right can be edited. A confidentiality 503 area is designed so that HIGH or LOW can be selected by pressing a radio button. As the administrator sets items, whose setting should be changed, and then presses an OK button 504, the setting of the security attribute and confidentiality can be changed.

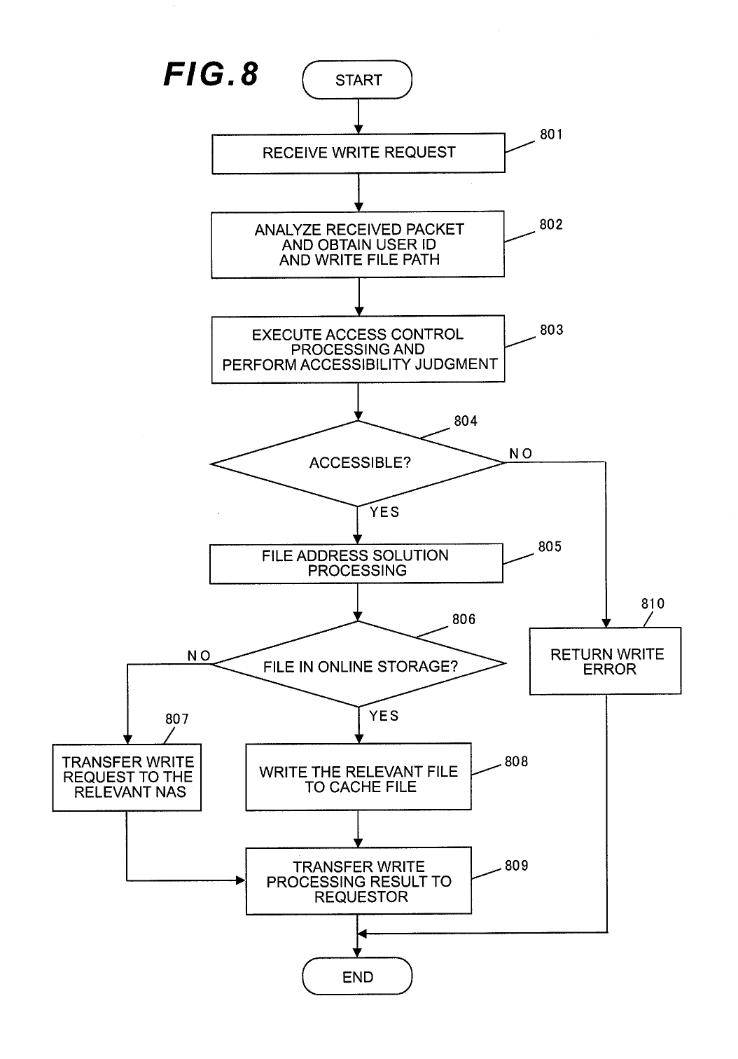

FIG. 6 is a flowchart illustrating processing for opening a file. When the CIFS/NFS module 107 receives a file open request from the user terminal 102 (step 601), it analyzes the received packet and obtains the user ID of the access source and a logical file path for the file to be opened (step 602).

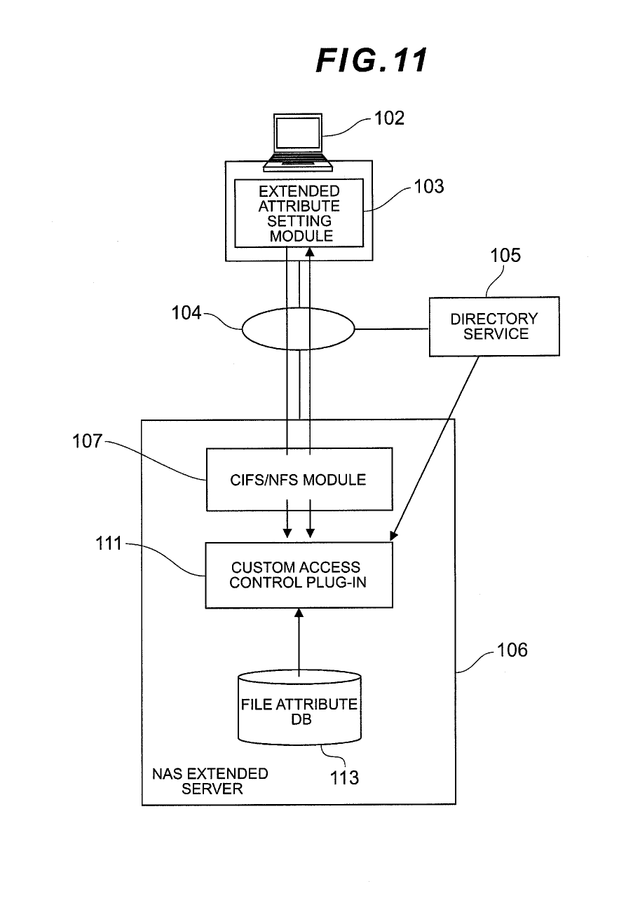

Next, after the CIFS/NFS module 107 invokes the custom access control plug-in module 111, the custom access control plug-in module 111 executes access control processing and executes processing for judging whether the file can be accessed or not (step 603). This access control processing will be explained in detail with reference to FIG. 9.

If the access is rejected as the result of this access judgment (step 604), the custom access control plug-in module 111 returns an open error to the user terminal 102 (step 610) and then terminates this processing. If the access is permitted, the custom access control plug-in module 111 inquires of the integrated name space service module 109 and obtains the real file address or the real file path from the logical file path (step 605).

In fact, the integrated name space service module 109 executes processing for solving this file address by using the file attribute DB 113. Specifically speaking, the integrated name space service module 109 refers to the file attribute DB 113, obtains the real file address 302 corresponding to the logical file path, and judges, based on the obtained real file address, whether the target file belongs to the online storage service 119 or the NAS 117 (step 606).

If it is found as the result of judgment that the target file exists in the NAS 117, the CIFS/NFS module 107 transfers the open request to the object NAS 117 (step 607), receives notice of a success or failure of such transfer, and then transfers the notice of success or failure to the requestor (step 609).

If it is found that the file exists in the online storage service 119, the CIFS/NFS module 107 opens the file in the online storage service by using the Web API (step 608) and then notifies the requestor of a success or failure of the file opening (step 609).

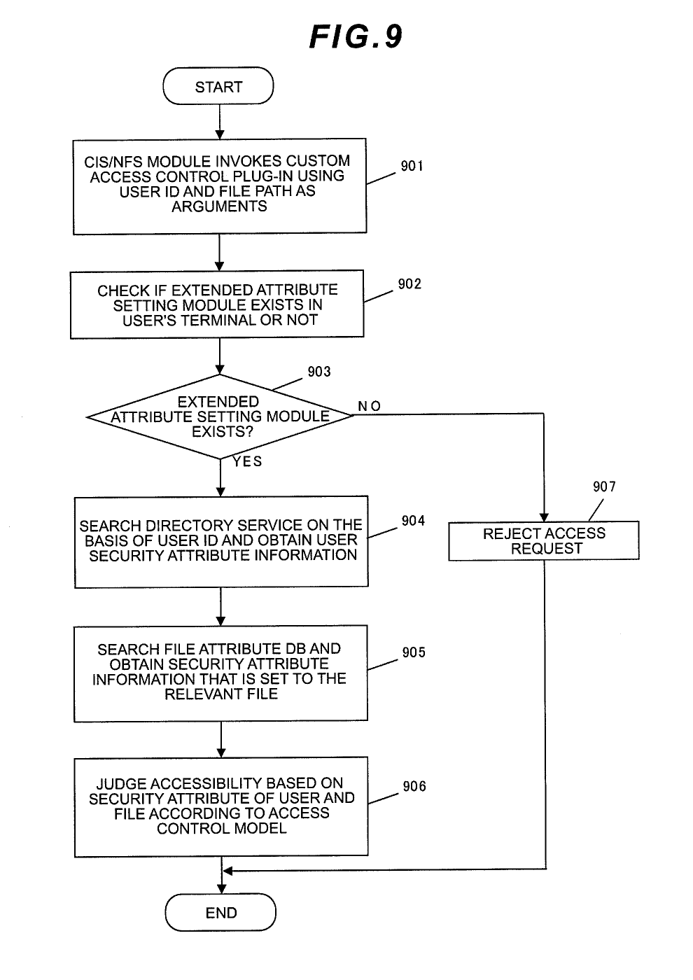

FIG. 7 is a flowchart illustrating file read processing. After the CIFS/NFS module 107 receives a READ request from the user terminal 102 (step 701), it analyzes the received packet and obtains the user ID and a file path for the file to be read (step 702).

Next, the CIFS/NFS module 107 invokes the custom access control plug-in module 111, and the custom access control plug-in module 111 executes the access control processing and performs the accessibility judgment (step 703). If the access is rejected as the result of the accessibility judgment (step 704), the custom access control plug-in module 111 returns a READ error to the user terminal and then terminates this processing (step 710).

If the access is permitted, the file address solution processing is executed as in the case of the file opening (step 705). Whether the file exists in the online storage service 119 or in the NAS 117 is judged based on the real file address obtained by this file address solution processing (step 706). If it is found that the file exits in the NAS 117, the CIFS/NFS module 107 transfers the READ request to the NAS and reads the file data (step 707) and then transfers the read data to the user terminal 102 which is the requestor (step 709).

On the other hand, if the file exists in the online storage service 119, the cache management service module 110 reads the data from the cache file 201 if the corresponding cache file 201 already exists in the secondary storage device 114 for the NAS extended server 106; or otherwise, the cache management service module 110 reads the relevant file using the Web API provided by the online storage service and creates a cache file 201 in the secondary storage device (step 708). Subsequently, the CIFS/NFS module 107 transfers the read data to the requestor (step 709).

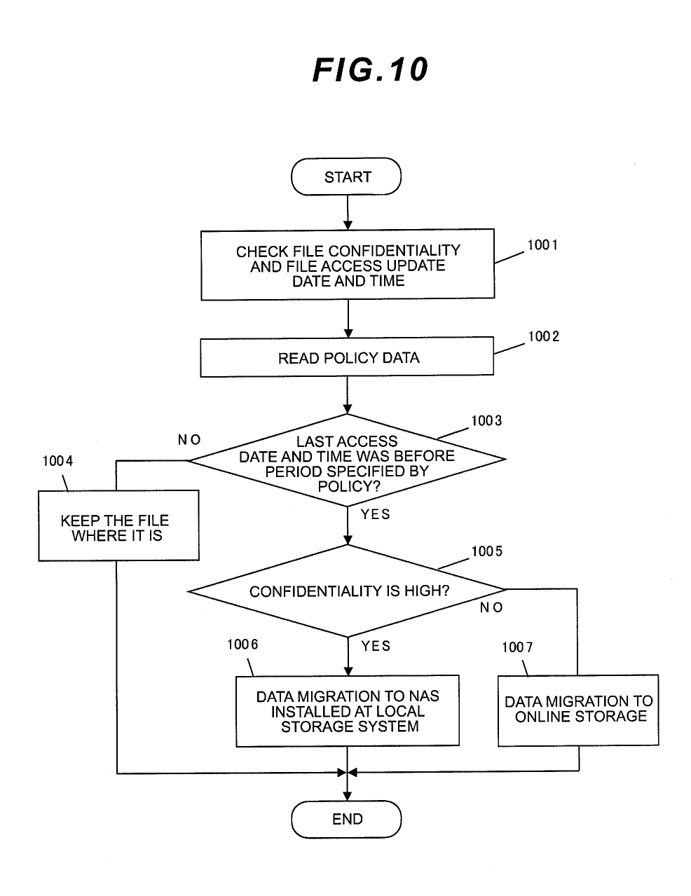

FIG. 8 is a flowchart illustrating file write processing. After the CIFS/NFS module 107 receives a WRITE request from the user terminal 102 (step 801), it analyzes the received packet and obtains the user ID and a file path for the file to be written (step 802).

Next, the CIFS/NFS module 107 invokes the custom access control plug-in module 111, and the custom access control plug-in module 111 executes the access control processing and performs the accessibility judgment (step 803). If the access is rejected as the result of the accessibility judgment (step 804), the custom access control plug-in module 111 returns a WRITE error to the user terminal and then terminates this processing (step 810).

If the access is permitted, the file address solution processing is executed as in the case of the file opening (step 805). Whether the file exists in the online storage service 119 or in the NAS 117 is judged based on the real file address obtained by this file address solution processing (step 806).

If the file exits in the NAS 117, the CIFS/NFS module 107 transfers the WRITE request to the NAS and writes the file data (step 807) and then transfers the result of the WRITE processing to the user terminal 102 which is the requestor (step 809). On the other hand, if the file exists in the online storage service 119, the cache management service module 110 executes overwrite processing on the cache file 210 if the corresponding cache file 201 already exists; or otherwise, the cache management service module 110 creates a new cache file 201 and writes the data to it (step 808). Subsequently, the CIFS/NFS module 107 transfers the result of the WRITE processing to the requestor (step 809).

FIG. 9 is a flowchart illustrating access control processing by the custom access control plug-in module 111. After the CIFS/NFS module 107 invokes the custom access control plug-in module 111 using, as arguments, the user ID and file path obtained from the access request packet (step 901), the custom access control plug-in module 111 checks whether or not the extended attribute setting module 103 exists in the user terminal 102 which is the access requestor (step 902).

Examples of this checking means include: a method executed by the custom access control plug-in module 111 by communicating with the extended attribute setting module 103, which is the requestor, and authenticating the extended attribute setting module 103 in a challenge-response form; a method executed by the extended attribute setting module 103 for generating a file with the encrypted authentication identifier before starting a session and sending it to the custom access control plug-in module 111; and a method of decoding and authenticating an encrypted identifier embedded by the extended attribute setting module 103, using an extended attribute according to the CIFS/NFS protocol. Any method can be used as long as the existence of the extended attribute setting module 103 in the user terminal 102, which is the requestor, can be confirmed; and this invention is not limited only to the use of the above-listed methods.

If it is found as the result of the check (step 903) that the extended attribute setting module 103 does not exist, the user terminal 102 which is the access requestor is a non-specific, general terminal and the custom access control plug-in module 111 rejects the access request and terminates this processing (step 907).

On the other hand, if the extended attribute setting module 103 exists, the custom access control plug-in module 111 first searches the directory service module 105 based on the user ID and obtains the security attribute information assigned to the user (step 904). Next, the custom access control plug-in module 111 searches the file attribute DB 113 and obtains the security attribute information which is set to the relevant file (step 905). The custom access control plug-in module 111 judges accessibility based on the security attribute information defined for each user and/or file according to the access control model (step 906).

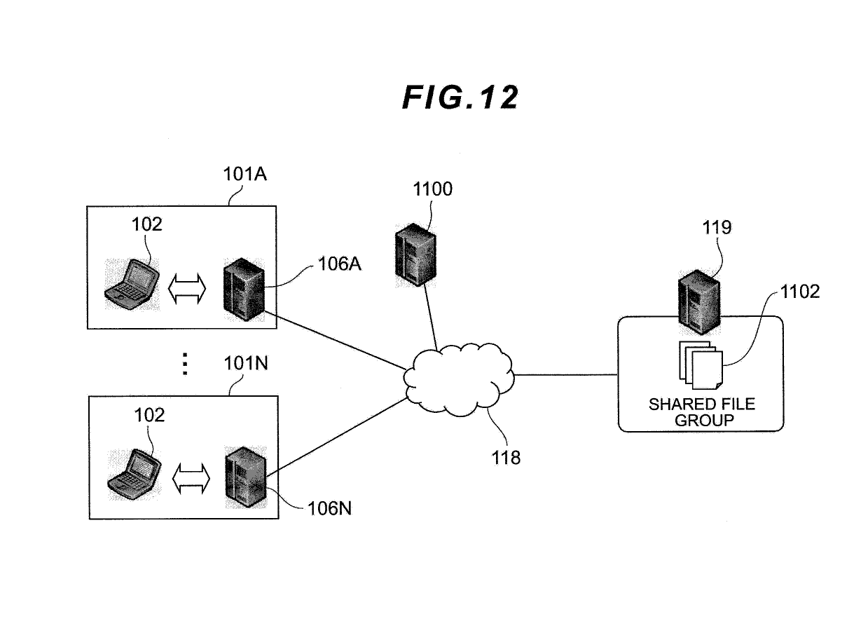

FIG. 10 is a flowchart illustrating data placement processing according to a policy. This data placement processing is processing executed by the data placement management service module 112 for periodically checking the attribute information about the cache file(s) 201 and files in the NASes 117 and performing appropriate data placement according to the policy set by the administrator.

Firstly, the data placement management service module 112 checks the confidentiality and file access update date and time of a cache file 201 or a file in the NAS 117 (step 1001). Next, the data placement management service module 112 reads policy data in which the file placement policy is described according to the access frequency and confidentiality (step 1002). The data placement management service module 112 judges based on the content of the policy data whether the last access date and time is before a period of time specified by the policy or not (step 1003).

If the last access date and time is after the period of time specified by the policy, the access frequency to the relevant file is considered to be high and the data placement management service module 112 keeps the file where it is located in the cache area without migrating the file (step 1004).

If the last access date and time is before the period of time specified by the policy, the file is to be migrated and the data placement management service module 112 checks the confidentiality in order to determine a migration destination (step 1005). If the confidentiality is high, migration to the online storage service 109 is prohibited and then the data placement management service module 112 migrates data to a NAS 117 installed in the company/organization.

In a case of the file which originally exists in the NAS 117, the file stays where it is located, or the data placement management service module 112 migrates the data to a designated, highly-reliable, and secure NAS 117 (step 1006). If the confidentiality is low, the data placement management service module 112 encrypts the file and migrates it to the online storage service (step 1007). After the data placement management service module 112 migrates the file data from the NAS extended server 106 to the NAS 117 or the online storage service 119, it purges the cache file in the secondary storage device 114 for the NAS extended server 106.

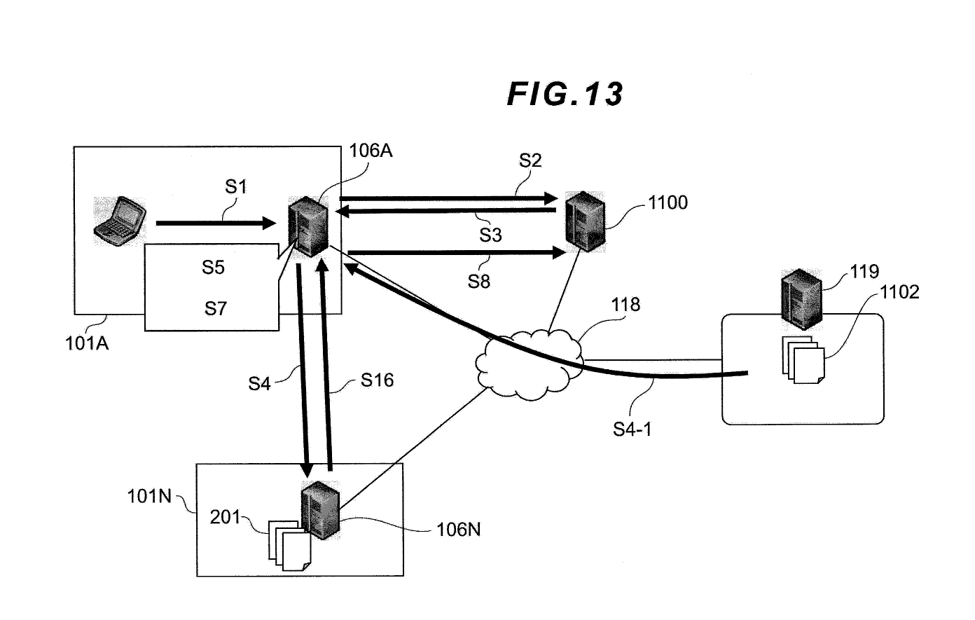

FIG. 11 is a block diagram showing the details of a unique access control mechanism that can be customized by the user by means of the extended attribute setting module 103. If the user A accesses file X managed by the NAS extended server 106 via the user terminal 102, a request to open the file X, which is issued by the user terminal 102, is sent to the CIFS/NFS module 107.

After receiving the open request, the CIFS/NFS module 107 assigns control to the custom access control plug-in module 111; and the custom access control plug-in module 111 communicates with the extended attribute setting module 103 for the user terminal 102, which is the sender, and checks if the extended attribute setting module 103 is installed in the user terminal 102 or not. Subsequently, the custom access control plug-in module 111 communicates with the directory service module and obtains the security attribute of the access user A.

Assuming that access control by the MCS is performed, the custom access control plug-in module 111 obtains, for example, {C1}. Subsequently, the custom access control plug-in module 111 obtains the security attribute of the file X from the file attribute DB 113. For example, the obtained attribute of the file X is {C1, C2}.

The custom access control plug-in 111 judges the security based on the obtained security attributes of the user and the file and then determines whether the open request can be satisfied or not. Since the attribute {C1, C2} of the file in this example is not included in the attribute {C1} of the user, the access is rejected.

Because of the configuration described above, the computer system can flexibly extend the NAS capacity using the online storage service and realize the optimum data placement with regard to the data in the NASes and the online storage service according to the confidentiality and access frequency which are set by the user.

Furthermore, as the mechanism for applying the unique access control mechanism, which is not used in the conventional CIFS/NFS, to the existing NASes is provided, it is possible to realize appropriate data protection which is suited for file sharing among a plurality of organizations/departments.

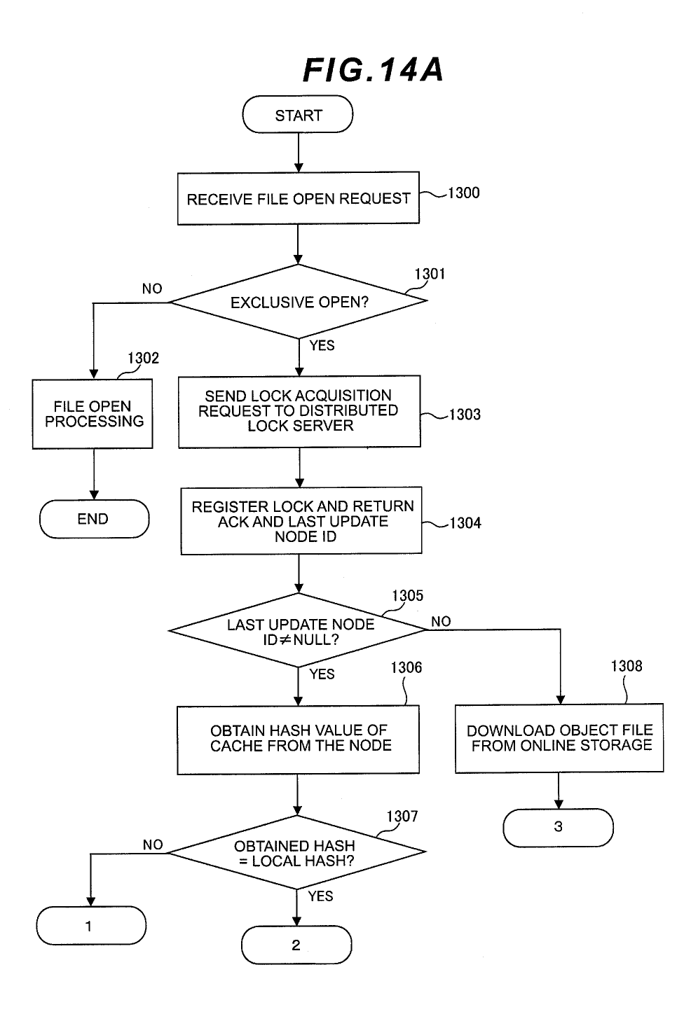

Next, a second embodiment of this invention will be explained. A computer system according to this embodiment is characterized by its function managing shared files that are shared by a plurality of local storage systems. The block configuration of this computer system is shown in FIG. 12. In this computer system, each of local storage systems 101A-101N is connected to a WAN 118. Furthermore, an online storage service 119 is connected to the WAN 118.

Each local storage system can access the cache file(s) in other local storage systems or a shared file (group) 1102 in the online storage service 119 via the WAN 118.

As the integrated name space service module 109 for each local storage system sets a virtually integrated directory space to the computer system shown in FIG. 12, the computer system can manage paths to the shared file(s) in an integrated manner.

The latest file shared by the plurality of local storage systems exists in the online storage service 119 or exists in a cache area in the local storage system before it is downloaded to the online storage service.

It is necessary to provide a file lock mechanism in the computer system in order to secure the result consistency of the shared files. However, since it is not appropriate to set the lock for the files through the intermediary of the WAN 118, provision of the file lock mechanism in the online storage service 119 is not favorable.

Therefore, it is necessary to set the file lock mechanism in the environment outside the online storage service 119. Then, it is necessary to set the file lock to the cache file in each of nodes (NAS extended servers 106) which are distributed over a wide area of the computer system, the computer system shown in FIG. 12 is provided with a distributed lock server 1100 for managing distributed lock and this distributed lock server 1100 is connected to the WAN 118.

The distributed lock server 1100 has a function managing the distributed locks with respect to each of the nodes distributed in the computer system in order to synchronize access to the shared file(s) as shared resources. The computer system shown in FIG. 12 is beneficial to a system, like a database system, in which the latest data must be secured for all the nodes.

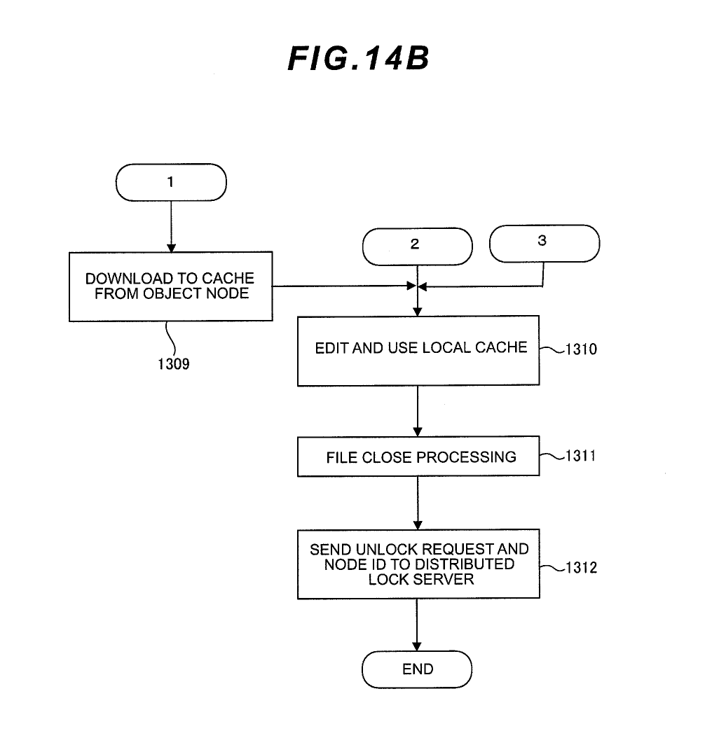

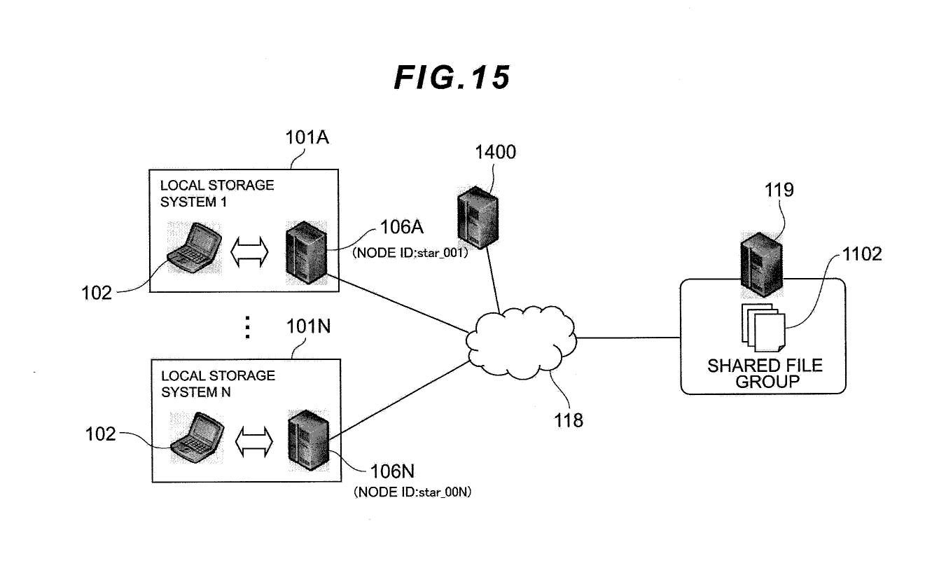

Next, the operation of the computer system shown in FIG. 12 will be explained with reference to a block diagram (FIG. 13) and flowcharts (FIGS. 14A and 14B).

The user terminal 102 sends a request to open a shared file to the node (NAS extended server 106A) (FIG. 13: S1). After the file system module 107 for the node 106A receives the file open request (FIG. 14A: 1300), the node 106A executes steps 601-604 in FIG. 6 and determines the logical path to the file.

Next, the file system module 107 for the node 106A judges whether the open request is issued in an exclusive mode or not (FIG. 14A: 1301); and if a negative judgment is returned, the file system module 107 executes file open processing without locking the shared file (FIG. 14A: 1302). The user terminal 102 which has issued the open request can have read-only access to the target file or execute write processing on the target file by treating it as a local file. Incidentally, the node 106A may return an open error to the user terminal 102.

On the other hand, if the node 106A returns an affirmative judgment in 1301, the file system module 107 sends the file ID to the distributed lock server 1100 and requests for the acquisition of the lock (FIG. 13: S2; and FIG. 14A: 1303).

The distributed lock server 1100 connects to each node (106A-106N) via the WAN 118, collects update information about the shared file from each node, and registers, in a management table, the identification information about the shared file and the ID of a node which executed the latest update to the shared file. If the shared file has been migrated from the local cache to the online storage service, the node ID becomes NULL.

After the distributed lock server 1100 receives the distributed lock acquisition request from the node, it refers to the management table, reads the last update node ID, and sends it together with ACK to the requestor node 106A (FIG. 13: S2; and FIG. 14A: 1304). Incidentally, the last update node is the node ID of the NAS extended server which executed the latest update to the target shared file.

The requestor node 106A which has received the ACK from the distributed lock server 1100 judges whether the last update node ID is NULL or not (FIG. 14A: 1305). If the last update node ID is NULL, the requestor node 106A downloads the shared file from the online storage service 119 to the local cache (FIG. 13: S4-1; and FIG. 14A: 1308).

This is because the node 106N corresponding to the node ID which executed the last update to the shared file has migrated the shared file from the local cache to the online storage service 119 and has purged the shared file in the local cache.

If the requestor node 106A determines that the last update node ID is not NULL, it obtains a hash value of the cache file 201 from the node 106N corresponding to the last update node ID (FIG. 32: S4; and FIG. 14A: 1306).

Subsequently, the requestor node 106A compares a hash value of its own cache file (local hash value) with the obtained hash value (FIG. 13: S5; and FIG. 14A: 1307); and if they are not equal to each other, it determines that the latest data does not exist in its own local cache, and the requestor node 106A then downloads the latest data of the shared file from the local cache for the object node 106N to its own local cache (FIG. 13: S6; and FIG. 14B: 1309).

On the other hand, if the requestor node 106A determines as the result of the above comparison that these two hash values are equal to each other, the requestor node 106A determines that it has the latest data in its own local cache and, therefore, it is unnecessary to download the shared file from the object node 106N.

Next, after the requestor node 106A obtains the latest shared file, it stores the latest shared file in its own local cache and executes edit processing on the shared file (FIG. 13: S7; and FIG. 14B: 1310).

Subsequently, the requestor node 106A executes file close processing (FIG. 14B: 1311) and then sends an unlock request for the target file and the ID of the requestor node to the distributed lock server 1100 (FIG. 13: S8; and FIG. 14B: 1312).

The distributed lock server 1100 accesses the management table, registers the ID of the requestor node to the target file ID, and clears a distributed lock flag.

Incidentally, if the requestor node 106A fails to read the hash value from the local cache for the object node 106N, it determines that the cache file in the object node 106N has been purged and data of the target shared file in the online storage service 119 is the latest data; and the requestor node 106A reads the data of the target shared file from the online storage service 119 to the local cache.

Incidentally, if a failure occurs in the distributed lock server 1100, the lock request from the requestor node 106A to the distributed lock server 1100 times out. So, the requestor node 106A returns an open error to the client.

If a failure occurs in the object node 106N, even if the requestor node 106A requests the cache hash value from the object node 106N, a response from the object node 106N times out. So, the requestor node 106A returns an open error to the client or obtains an old version file from the online storage service 119 and returns it to the client. Furthermore, if a failure occurs in the online storage service 119, the requestor node 106N returns an open error to the user terminal 102.

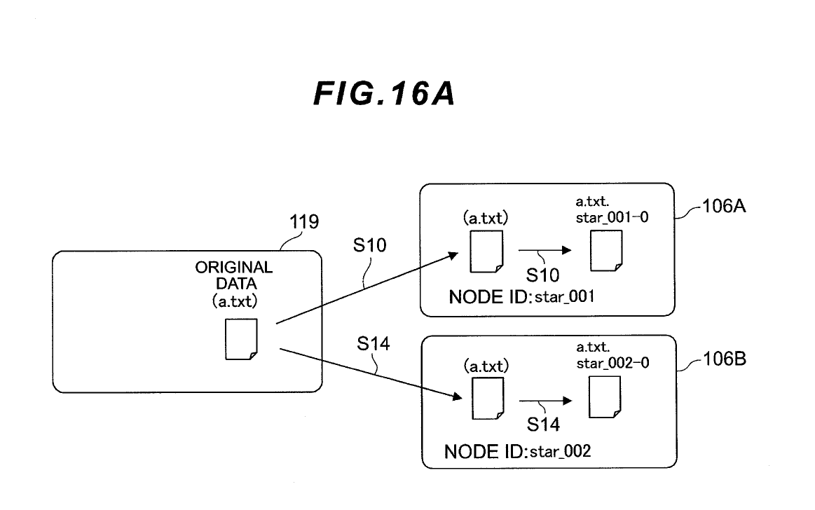

Next, a third embodiment of this invention will be explained. A computer system according to this embodiment is characterized in that it does not use the distributed lock management method as in the above-described second embodiment as the shared file management method, but it uses a method of committing a plurality of update data files, which derive from original data, as shared file(s). The block diagram of the computer system according to this embodiment is shown in FIG. 15. The commit processing is processing executed by the authorized administrator for confirming or determining a specific file, from among a plurality of files, as a shared file. The commit processing is completed by selection of the specific file from among the plurality of files by the administrator via, for example, a GUI.

This computer system includes N units of the NAS extended servers 106 whose node IDs are, for example, from star_001 to star_00N, and a commit server 1400 instead of the distributed lock server 1100 according to the second embodiment. This computer system is suited for use in a shared document file management system.

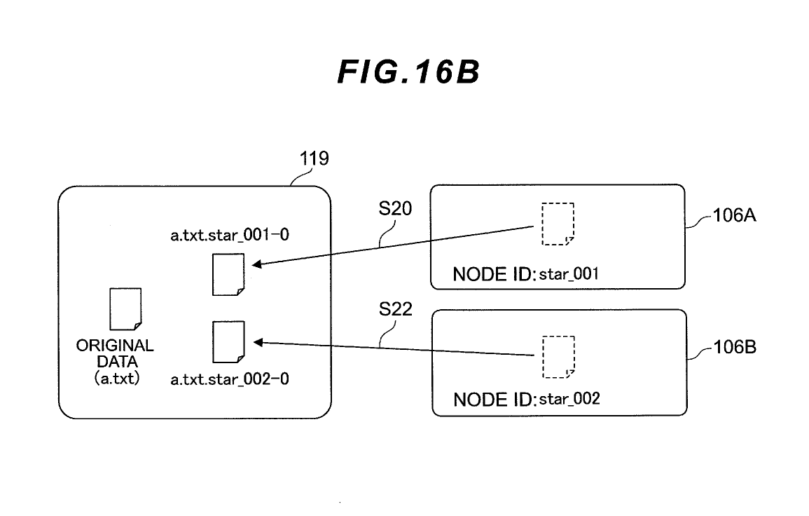

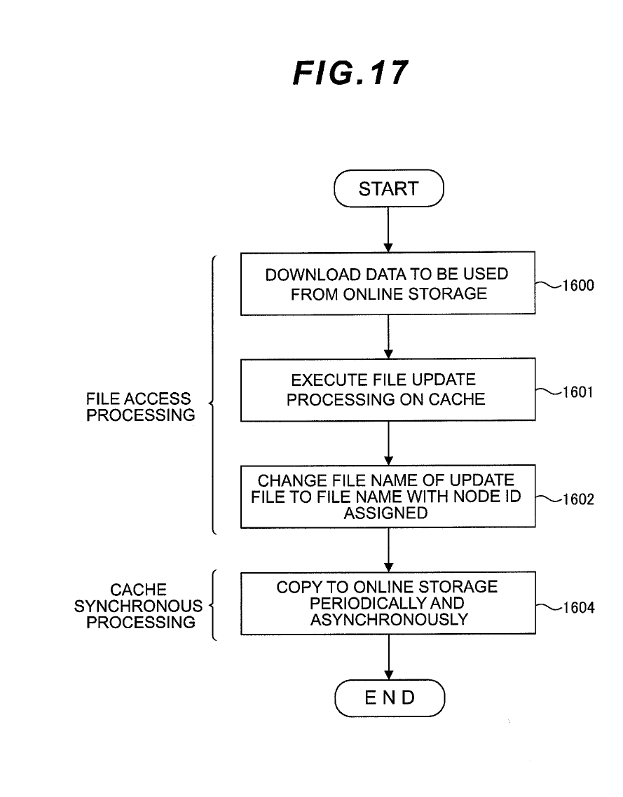

Next, commit processing will be explained with reference to block diagrams and a flowchart. FIGS. 16A and 16B are block diagrams of update processing on an original data file and FIG. 17 is a flowchart illustrating update processing.

Referring to FIG. 16A, an original data file (a.txt) exists in the online storage service 119. The NAS extended server 106A (node ID: star_001) which is a first node downloads the original data file (file name: a.txt) from the online storage service 119 to the local cache in response to a file open request from the user terminal 102 (FIG. 16A: S10; and FIG. 17: 1600).

Next, The NAS extended server 106A updates the original data file (a.txt), which has been downloaded to the local cache, and stores it in its local cache (FIG. 16A: S12, FIG. 17: 1601). When doing so, the first node changes the file name of the update file to a file name (a.txt.star_001-0) by adding the node ID to the file name of the original data file (FIG. 17: 1602). Similarly, the NAS extended server 106B (node ID: star_002) which is a second node also stores an update file (a.txt.star_002-0) to its local cache in the same manner as in the first node (FIG. 16A: S 14). The above-described processing is processing for updating the shared file.

Next, as shown in FIG. 16B, the first node 106A periodically executes asynchronous copying of the update file in its local cache to the online storage service 119 (FIG. 16B: S20; and FIG. 17: 1604). The online storage service stores the update file (a.txt.star_001-0) as a derived data file separately from the original data file without overwriting the original data file (a.txt). The first node 106A purges the update file in its local cache as shown with a dashed line. Similarly, the second node 106B stores the update file (a.txt.star_002-0) in the online storage service 119 (FIG. 16B: S22; FIG. 17: 1604)). The above-described processing is cache synchronous processing.

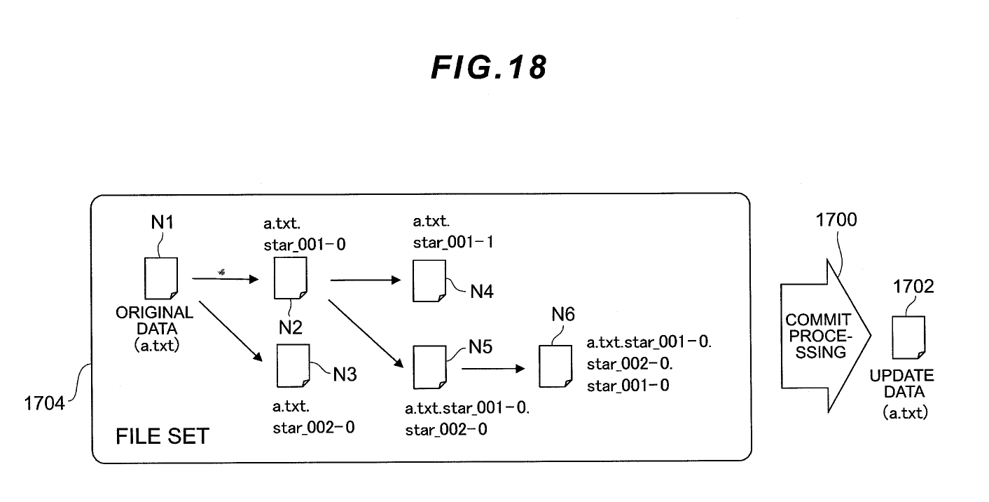

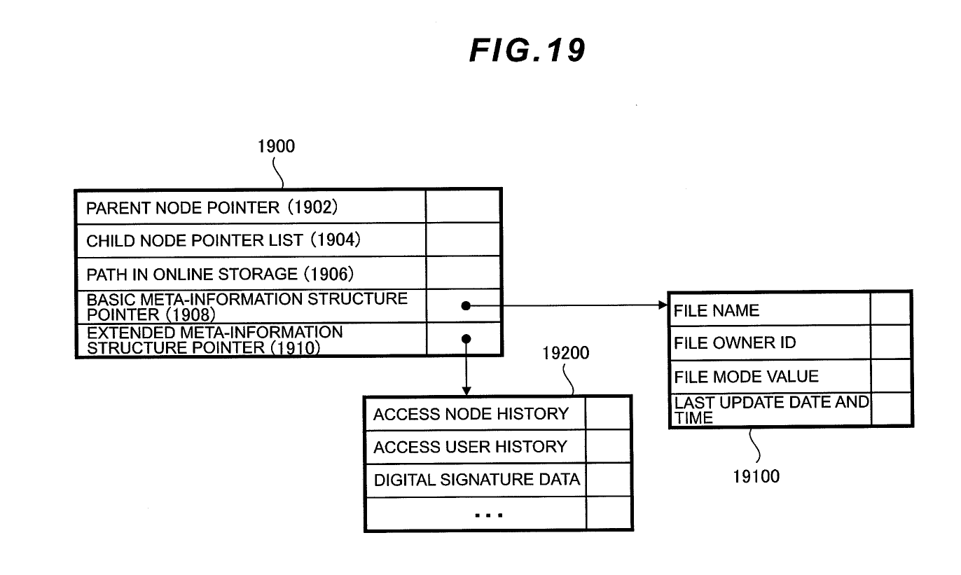

A set of the original data file and derived data files can be as shown in FIG. 18. In this file set, the nodes N1 to N6 constitute the tree configuration of the file set. The data configuration of each component node is shown in FIG. 19.

This data configuration 1900 includes a parent node pointer 1902, a child node pointer 1904, a path in online storage 1906, a basic meta-information structure pointer 1908, and an extended meta-information structure pointer 1910.

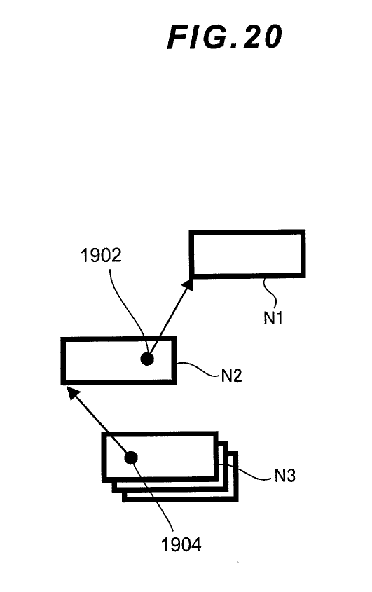

When focusing on a certain node, a parent node is a node located upstream in the file set. A child node is a node located downstream in the file set. Assuming that the certain node is N2 as shown in FIG. 20, the node N2 is mapped by the parent node pointer (1902) to a parent node N1 and is also mapped by the child node pointer (1904) to a child node N3.

The node(s) is mapped by the path in online storage (1906) shown in FIG. 19 to a file in the online storage service 119. The node is mapped by the basic meta-information structure pointer (1908) to basic meta-information 19100. The basic meta-information 19100 includes a file name, a file owner ID, a file mode value, and a last update date and time. The node is mapped by the extended meta-information structure pointer (1910) to extended meta-information 19200. The extended meta-information includes access node history, access user history, and digital signature data.

When the NAS extended server 106 stores the update file in the online storage service 119 (FIG. 17: 1602, 1604), it sends metadata to the commit server 1400. When sending the metadata of the update file to the commit server 1400, the NAS extended server 106 further sends meta-information of the original data file.

The commit server 1400 sets the data configuration 1900 from the metadata, constructs the tree configuration (FIG. 18) of the file set 1704 from this data configuration, creates an image of the tree configuration, and provides it via a GUI to a management device for the commit server 1400.

The administrator of the commit server 1400 selects a desired node in the file set and commits it (FIG. 18: 1700). The commit server 1400 refers to the configuration data 1900 about the committed node and identifies the file ID mapped to the node. The committed file becomes a shared file and the original data file ID is assigned to the commit file (FIG. 18: 1702)

The commit server 1400 sends a command to delete other files, except for the committed file, to the online storage service 119. Incidentally, there may be a plurality of files to be committed.

Trigger events for executing the commit processing are: a trigger event where a command is given by the administrator to the commit server; a trigger event where the commit server determines that the number of files constituting the file set has reached a threshold value; a trigger even where the amount of data belonging to the file set exceeds a threshold value; and a trigger event where the size of one or more files belonging to the file set exceeds a threshold value. Incidentally, the execution of the commit processing can prevent an increase of the storage capacity occupied by the online storage service.

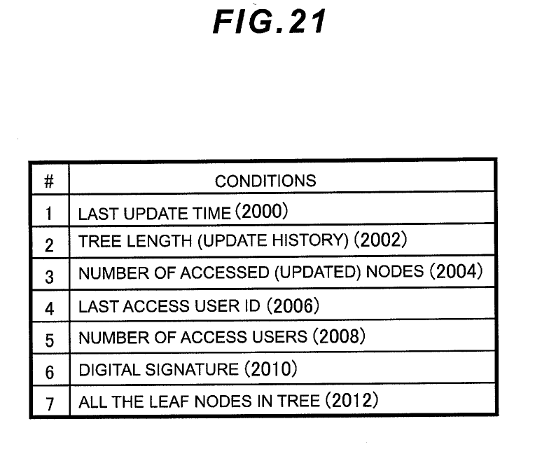

FIG. 21 shows a policy table 2000 defining policies for the commit processing. The commit server automatically determines a node (file) to be committed according to the policy. This policy table and the aforementioned data configuration and meta-information are stored in a specified storage area in the commit server.

In the policy table 2000, all the following entries exist: last update time 2002, tree length (update history) 2004 of the file set, a last access user ID 2006, the number of access users 2008, a digital signature 2010, and all the leaf nodes (terminal nodes) of the tree 2012.

The last update time 2002 is a policy for committing a file in the file set, on which edit processing was executed last time. The tree length (update history) 2004 of the file set is a policy for committing a derived node whose number of updates to the original data is the largest.

The last access user ID 2006 is a policy for committing a file node which has been referred to or updated by a user of the highest importance level. The directory service module 105 for each NAS extended server can retain importance rank data relating to the user IDs so that the commit server can determine the importance level of the user ID.

The number of access users 2008 is a policy for committing a file that is determined to be important because of the largest number of access users. The digital signature 2010 is a policy for committing a file which has been digitally signed. The entry stating all the leaf nodes (terminal nodes) of the tree 2012 is a policy for committing a file existing in a leaf node of the tree.

Whether the node is a leaf node or not can be determined based on whether the child node pointer 1904 (FIG. 19) exists or not. In other words, a node to which the child node pointer is not mapped is a leaf node.

A policy validating flag can be set by the administrator of the commit server to each entry in the commit table. The policy to which the flag is set is validated. The administrator can set a detailed policy to each entry.

If a plurality of policies are validated, either the logical OR or the logical AND should be prioritized is decided depending on the setting made by the administrator.

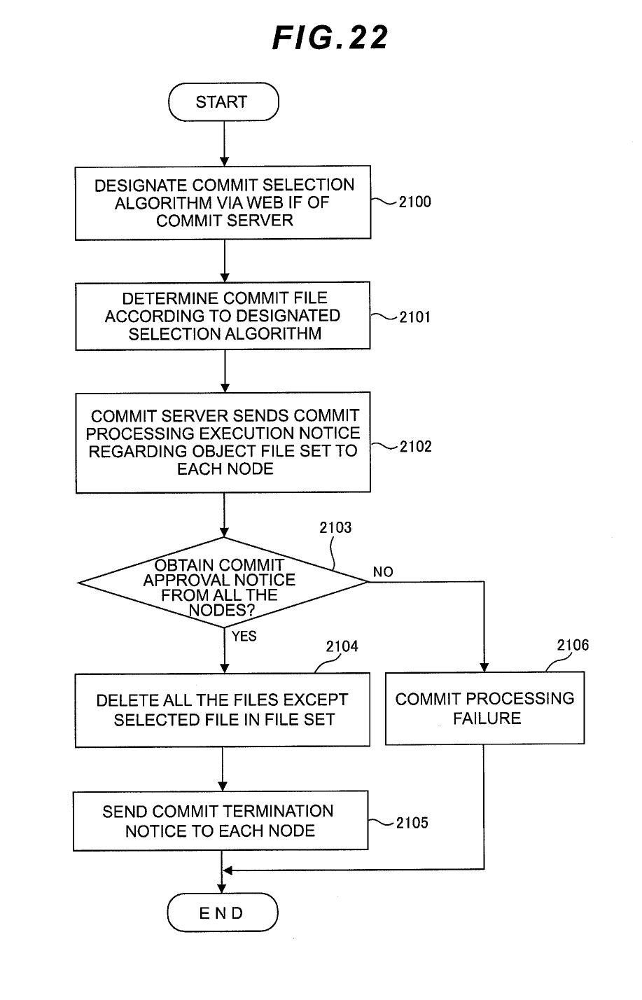

Next, the commit processing will be explained with reference to a flowchart (FIG. 22). The authorized administrator of the commit server 1400 sets a policy (policies) to the commit table via a WEBIF for the commit server 1400 (2100). The commit server 1400 refers to the commit table and commits a specific file based on an algorithm 2101 selected by the commit table (2101).

Subsequently, the commit server 1400 sends notice of execution of the commit processing on the target file set to each node (NAS extended server) (2102). Then, the commit server 1400 judges whether it has obtained commit approval notice from all the nodes (2103); and if a negative judgment is returned, the commit server 1400 notifies the commit execution administrator of a failure of the commit processing (2106).

Incidentally, the setting may be made so that the commit server can start the commit processing if it receives the commit approval from some of the nodes.

If the commit server returns an affirmative judgment, it sends a command to delete all the files, except for the committed file, to the online storage service 119 (2104). Next, the commit server 1400 notifies each node (NAS extended server) of the commit processing (2105).

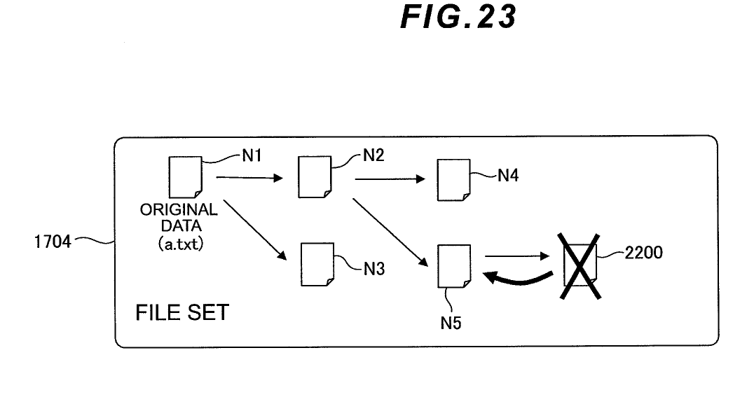

Incidentally, the commit server may set a policy to immediately delete all the files except for the committed file. For example, after the elapse of a certain period of time from the commit processing, the commit server sends a deletion command to the online storage service 119. If the committed file 2200 is deleted as the result of the above command as shown in FIG. 23, the commit server 1400 can reproduce the shared file by returning to the previous upstream parent node.

It should be noted that the commit server can execute batch commit processing on a plurality of file sets based on the commit table.

Incidentally, both the shared file management by the distributed lock method and the shared file management by the commit method can be used by providing the computer system with the distributed lock server 1100 and the commit server 1400. For example, a flag indicating that the relevant data is suited for either the shared file management by the distributed lock method or the shared file management by the commit method may be set to the file attributes, so that the commit server can select the best suited method according to the flag.

### REFERENCE SIGNS LIST

101 Company/organization

102 User terminal

103 Extended attribute setting module

104 LAN

105 Directory service module

106 NAS extended server

107 CIFS/NFS module

108 Access control plug-in manager module

109 Integrated name space service module

110 Cache management service module

111 Custom access control plug-in module

112 Data placement management service module

113 File attribute DB

114 Secondary storage device

115 Policy data

116 NAS connection LAN

117 NAS

118 WAN

119 Online storage service

201 Cache file

202 High-frequency access file group

203 Low-frequency access file group

204 Confidential file group

301 Logical file path

302 Real file address

303 Size

304 Access date and time

305 Update date and time

306 Confidentiality

307 Access control model

308 Security attribute

309 Cache flag

1. A computer system with a local storage system and an external storage service connected via a wide area network,
wherein the local storage system includes:
a user terminal;
an NAS for providing a storage area to the user terminal; and
an information processing unit for providing the user terminal with the storage area in the NAS by integrating the NAS and the external storage service and thereby configuring a single virtual NAS; and
wherein the information processing unit includes:
a first module for analyzing a file access request from the user terminal and obtaining a path to an access target file;
a second module for judging whether access to the access target file should be permitted or not;
a third module for configuring a single virtual directory and managing the path to the file based on the directory; and
a fourth module for migrating the file to the external storage service based on attribute information about the file.

2. The computer system according to claim 1, wherein the second module applies a unique access control function to the file access.

3. The computer system according to claim 1, wherein the fourth module determine a file attribute of the access target file accessed by the user terminal and migrate the file to the NAS or the external storage system according to the file attribute.

4. The computer system according to claim 2, said information processing unit further comprising:
a sixth module having attribute information for unique access control that is set to a requestor of the access request; and
a database having an attribute of the file; and
wherein the second module analyzes a protocol of the file access, obtains an account of the access requestor and file path information, inquires of the sixth module based on the obtained information, and then obtains a first attribute of the unique access control;
accesses the file attribute database and obtains a second attribute of the access control corresponding to the access target file; and
judges based on the first attribute and the second attribute whether access to the access target file should be permitted or not.

5. The computer system according to claim 4, wherein the second module judges whether a module for setting the unique access control is implemented in a user terminal of the access requestor or not; and
If a negative judgment is returned, the file access request is rejected.

6. The computer system according to claim 1, wherein a plurality of local storage systems are connected to the wide area network,
a shared file shared by the plurality of local storage systems exists in at least one cache for the plurality of local storage systems or in the external storage service, and
the computer system further comprises a distributed lock server for managing a distributed lock for the shared file.

7. The computer system according to claim 6, wherein the distributed lock server has identification information about a local storage system which has executed a latest update to the shared file; and
a local storage system which has received a file open request from the user terminal sends a lock acquisition request to the distributed lock server,
analyzes a response from the distributed lock server and obtains the identification information, and
obtains the shared file for the local storage system specified by the identification information and executes processing on the shared file.

8. The computer system according to claim 7, wherein the local storage system which has received the file open request from the user terminal determines that the response from the distributed lock server does not include the identification information, it obtains the shared file from the external storage service.

9. The computer system according to claim 7, wherein if the local storage system which has received the file open request from the user terminal terminates the processing on the shared file, it issues an unlock request and its own identification information to the distributed lock server.

10. The computer system according to claim 1, wherein a plurality of local storage systems are connected to the wide area network;
wherein when the external storage service stores a shared file which is shared by the plurality of local storage systems and is updated by one or more local storage systems from among the plurality of local storage systems, the external storage service stores both a pre-update shared file and a post-update shared file;
wherein a file set is constituted from the pre-update shared file and the post-update shared file; and
wherein the computer system has a server for confirming on one or more files belonging to the file set as the shared file.

11. The computer system according to claim 10, wherein the server has a policy table in which a policy is registered; determines a file on which a commit processing is executed according to the policy, from among a plurality of files constituting the file set, and deletes said shared file, on which the commit processing has not been executed, from the external storage service.

12. The computer system according to claim 11, wherein the server sends a notice to request approval of the commit processing to the plurality of local storage systems; and if all the local storage systems approve the commit processing, the server executes the commit processing.

13. A data capacity extension method for a computer system with a local storage system and an external storage service connected via a wide area network,
wherein the local storage system includes:
a user terminal;
an NAS for providing a storage area to the user terminal; and
an information processing unit for providing the user terminal with the storage area in the NAS by integrating the NAS and the external storage service and thereby configuring a single virtual NAS; and
wherein the information processing unit executes:
a first step for analyzing a file access request from the user terminal and obtaining a path to an access target file;
a second step for judging whether access to the access target file should be permitted or not;
a third step for configuring a single virtual directory and managing the path to the file based on the directory; and
a fourth step for migrating the file to the external storage service based on attribute information about the file.
